(19) United States
(12) Patent Application Publication
(10) Pub. No.: US 2024/0106383 A1
(43) Pub. Date: Mar. 28, 2024

(54) U-CLAMP

(71) Applicant: RMS Services LLC, Terre Haute, IN (US)

(72) Inventor: Seth Recknor, Terre Haute, IN (US)

(73) Assignee: RMS Services LLC, Terre Haute, IN (US)

(21) Appl. No.: 18/474,648

(22) Filed: Sep. 26, 2023

Related U.S. Application Data
(60) Provisional application No. 63/377,071, filed on Sep. 26, 2022.

(51) Int. Cl. H02S 20/20; F16B 2/06

(52) U.S. Cl. CPC H02S 20/20; F16B 2/065

(57) ABSTRACT

A device and method for connecting and securing two or more perpendicular braces, angles, brackets, or framework elements. The device provides a solution for situations where conventional fastening methods such as drilling, welding, and/or other similar techniques may be prohibited or impractical. In one embodiment, the device is a U-shaped clamp configured to be employed for a temporary and/or a permanent connection for solar panels and metal frameworks. In another embodiment, the device is further configured to provide electrical connection between the solar panels and the metal frameworks.

### CROSS REFERENCE TO RELATED APPLICATIONS

This application claims the benefit of U.S. Patent Application No. 63/377,071, filed Sep. 26, 2022, which is hereby incorporated by reference.

### BACKGROUND

Solar panels harness sunlight to generate electricity, offering an environmentally friendly and sustainable energy solution. In recent years, solar panels are widely used on various structures, particularly on rooftops of residential and commercial buildings. However, installing solar panels on rooftops poses significant challenges, characterized by labor-intensive processes and demanding reliability standards as prolonged exposure to environmental factors can result in roof deformations, which jeopardizes the security of the solar panels and creates potential safety hazards.

Thus, there is a need for improvement in this field.

### SUMMARY

It was found that traditional methods such as drilling, welding, or similar techniques for connection may be prohibited or impractical due to limited operational space and/or angle during solar panel and/or other device installations. Moreover, if done improperly, the traditional methods may risk structural integrity of the mounting structures and compromise safety.

To address these as well as other issues, a unique system and method for connecting and securing two or more perpendicular braces, angles, brackets, or frameworks has been developed. The system provides a low-cost solution for situations where traditional fastening methods may be prohibited or impractical. In one embodiment, the system includes a solar panel, a frame, and a U-shaped clamp configured to be employed for a temporary and/or a permanent connection between the solar panel and the frame. In one embodiment, the solar panel includes an array of photovoltaic cells configured to generate electric current when stroked by photons from sunlight. The photovoltaic cells are encapsulated within a protective layer and an insulation layer. The protective layer shields the photovoltaic cells from environmental factors such as temperature, humidity, and/or dust. The insulation layer keeps the photovoltaic cells electrically insulated. In one embodiment, the frame is a metal rack that supports the solar panel on a structure such as a rooftop or a solar panel base. Alternatively or additionally, the frame may provide structural supports for more than one solar panels in a large solar power system. According to some embodiments, the frame further provides an electrical path for the solar panels. As such, the solar panels are grounded through the frame, which ensures that the entire system is at the same electrical potential to prevent potential differences that could lead to electrical hazards.

In one embodiment, the U-shaped clamp includes a body and a fastening set. The body forms a U-shaped profile on a first axis, where the body is curved at a center portion and extends on each side in a flat manner to a pair of ends located on a first plane. The body includes a first face and a second face, where each face corresponds to a substantially flat side of the body. The first face and the second face define an opening. The opening is configured to hold the frames to be connected. In one example, the first face is parallel to the second face, such that both the first face and the second face are oriented in a substantially vertical direction with respect to the first plane. In another example, the first face is inclined at an angle less than 90 degrees with respect to the first plane. As should be appreciated, other inclinations are possible for the first face and/or the second face with respect to the first plane. The first face and the second face each defines one or more apertures. In one particular version, only the first face defines one or more apertures. According to one embodiment, the apertures on the first face are positioned along a second axis that is located at the center of the first face and parallel to the first axis. Each of the apertures on the first face and each of the corresponding apertures on the second face form a pair and are located on a third axis transverse the second axis. As should be appreciated, other arrangements of the apertures are available. In one version, the body further includes a first tab extending from the first face, and a second tab extending from the second face. The first and the second tabs each has a first end, a second end, and a cut end. The second end corresponds to the end of the body. The cut end is positioned parallel and opposite to the second end of the tab. The first end is in communication with both the second end and the cut end. The first tab and the second tab define a cutout. The cutout is in communication with the opening so that a user can position the tabs at an angle and/or a position that is difficult to be reached by the U-shaped clamp through the opening.

In one embodiment, the fastening set includes two long bolts and two short screws. The long bolts and the short screws are configured to be threaded into the apertures and to facilitate the U-shaped clamp to provide a pressured connection. In a particular example, the long bolts are hex head bolts configured to be threaded into the apertures on the first face, and the short screws are cone point screws configured to be threaded into the apertures on the second face. As should be appreciated, the fastening set may include other quantities and/or styles of fasteners.

In one use example, an edge of the solar panel is placed transverse a frame forming a connection area. The U-shaped clamp having two cone point screws on the second face and two hex head bolts on the first face is advanced towards the frame so that the frame is set into the opening and touches against the center portion of the body of the U-shaped clamp. The connection area is positioned in the cutout of the body, with the second tab placed outside the edge of the solar panel and the first tab placed outside the frame. Put differently, the second tab and the first tab form a sandwich arrangement with respect to the connection area. Once the U-shaped clamp is in a desired position, the hex bolts are tightened to cause the cone point screws to bite down into the edge of the solar panel and/or the frame without tighten the cone point screws. As should be appreciated, the hex head bolts are also held against the edge of the solar panel and/or the frame as a result of the tightening.

In one version, the body is made of a rectangular metal plate having a thickness. The body is manufactured by stamping, puncturing, bending, cutting, and/or other machining processes. In one embodiment, the metal plate is made of steel. As should be appreciated, other metals having similar strength, elasticity, and/or other characteristics may be used. The metal plate may be coated and/or surface processed to obtain desirable aesthetics and protection against corrosion. In another version, the body is made of a composite material manufactured by processes including, but not limited to, heat injection molding.

The U-shaped clamp in another embodiment is configured to create an electrical bond between the solar panel and the metal rack. Thus, the U-shaped clamp serves a dual-purpose of mechanically bonding the frame with the solar panel together to hold the solar panel in place and creating an electrical path for grounding electricity generated from the solar panel. In one example, the U-shaped clamp provides a maximum current protection level of up to 25 amps.

The system and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a first frame.

Aspect 3 generally concerns the system of any previous aspect including a second frame.

Aspect 4 generally concerns the system of any previous aspect including a clamp.

Aspect 5 generally concerns the system of any previous aspect in which the clamp connecting the first frame to the second frame.

Aspect 6 generally concerns the system of any previous aspect in which the clamp has a body.

Aspect 7 generally concerns the system of any previous aspect including one or more fasteners.

Aspect 8 generally concerns the system of any previous aspect in which the body has a U-shaped profile.

Aspect 9 generally concerns the system of any previous aspect in which the body is curved at a center portion and extends on each side in a flat manner to a pair of ends located on a first plane.

Aspect 10 generally concerns the system of any previous aspect including a first face.

Aspect 11 generally concerns the system of any previous aspect including a second face.

Aspect 12 generally concerns the system of any previous aspect including an opening defined by the first face and the second face.

Aspect 13 generally concerns the system of any previous aspect in which the opening is configured to hold the frames to be connected.

Aspect 14 generally concerns the system of any previous aspect in which the first face and the second face are oriented in a substantially vertical direction with respect to the first plane.

Aspect 15 generally concerns the system of any previous aspect in which the first face is inclined at an angle more than 90 degrees with respect to the first plane.

Aspect 16 generally concerns the system of any previous aspect including one or more apertures defined by the body.

Aspect 17 generally concerns the system of any previous aspect in which the fasteners include two hex head bolts and two cone point screws.

Aspect 18 generally concerns the system of any previous aspect in which the fastener is configured to be threaded into the apertures and to facilitate the clamp to provide a pressured connection.

Aspect 19 generally concerns the system of any previous aspect in which the body is made of a metal plate having a thickness.

Aspect 20 generally concerns the system of any previous aspect in which the metal plate is cold-rolled steel.

Aspect 21 generally concerns the system of any previous aspect in which the metal plate is galvanized steel.

Aspect 22 generally concerns the system of any previous aspect in which the body is surface-processed to obtain desirable aesthetics and protection against corrosion.

Aspect 23 generally concerns the system of any previous aspect in which the body is made of a composite non-metal material.

Aspect 24 generally concerns the system of any previous aspect in which the clamp is configured to create an electrical bond between the frames.

Aspect 25 generally concerns the system of any previous aspect in which the frame is configured to provide an electrical path.

Aspect 26 generally concerns the system of any previous aspect in which the clamp is configured to provide a maximum current protection level of 25 amps.

Aspect 27 generally concerns the system of any previous aspect including a first tab extending from the first face.

Aspect 28 generally concerns the system of any previous aspect including a second tab extending from the second face.

Aspect 29 generally concerns the system of any previous aspect including a cutout defined by the first tab and the second tab.

Aspect 30 generally concerns the system of any previous aspect including a solar panel.

Aspect 31 generally concerns the system of any previous aspect in which the solar panel is supported by the first frame.

Aspect 32 generally concerns the system of any previous aspect in which the fasteners are coupled to the body.

Aspect 33 generally concerns a method.

Aspect 34 generally concerns the method of any previous aspect including forming a connection area by placing a first frame proximal to a second frame.

Aspect 35 generally concerns the method of any previous aspect including advancing a U-shaped clamp having two cone point screws and two hex head bolts towards the connection area.

Aspect 36 generally concerns the method of any previous aspect including tightening the two hex head bolts against one of the frames to cause the cone point screws bite down into the other frame without tighten the cone point screws.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagram of a system according to one example.

FIG. 2 is an enlarged view of the system displayed in FIG. 1.

FIG. 3 is an enlarged end view of the system displayed in FIG. 1.

FIG. 4 is a perspective view of a clamp body according to one example.

FIG. 5 is an enlarged top view of a system according to one example.

FIG. 6 is a top view of a clamp body according to one example.

FIG. 7 is a side view of the first face displayed in FIG. 6.

FIG. 8 is a cross-sectional view of the clamp body displayed in FIG. 4.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

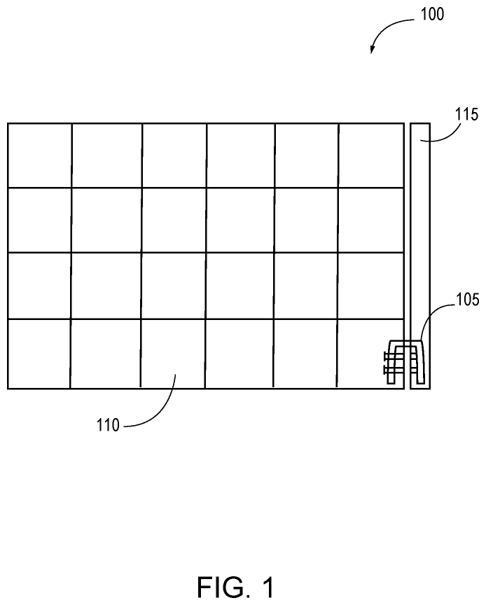

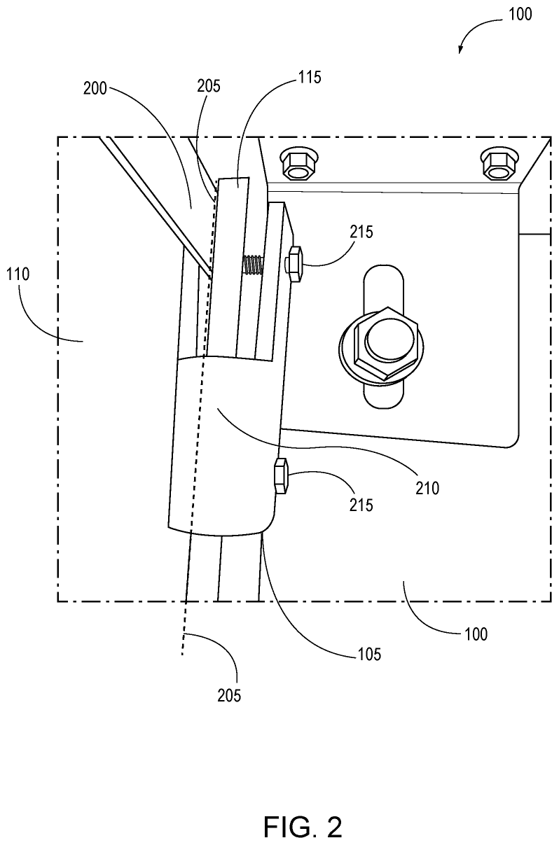

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 illustrates a system 100 according to one embodiment. The system 100 includes a clamp assembly 105, a solar panel 110, and a frame 115. As shown, the clamp assembly 105 is a U-shaped clamp configured to be employed for a temporary and/or a permanent connection between the solar panel 110 and the frame 115. The solar panel 110 includes an array of photovoltaic cells configured to generate electric current when struck by photons from sunlight. The photovoltaic cells are encapsulated within a protective layer and an insulation layer. The protective layer shields the photovoltaic cells from environmental factors such as temperature, humidity, and/or dust. The insulation layer keeps the photovoltaic cells electrically insulated. In the illustrated example, the frame 115 is a metal rack that supports the solar panel 110 on a structure such as a rooftop or a solar panel base. Alternatively or additionally, the frame 115 may provide structural support for more than one solar panels 110 in a large solar power system. According to some embodiments, the frame 115 may further provide an electrical path for the solar panels 110, so that the solar panels 110 are grounded through the frame 115, ensuring the entire system 100 is at the same electrical potential to prevent potential differences that could lead to electrical hazards. In some embodiments, the clamp assembly 105 is configured to create an electrical bond between the solar panel 110 and the frame 115. Thus, the clamp assembly 105 serves a dual-purpose of mechanically bonding the solar panel 110 with the frame 115 together and creating an electrical path for grounding electricity generated from the solar panel 110. In one example, the clamp assembly 105 provides a maximum current protection level of up to 25 amps.

An enlarged view of the system 100 according to one example is illustrated in FIG. 2. As aforementioned, traditional fastening methods may be prohibited or impractical in situations where two frameworks to be secured are positioned perpendicular to each other. For instance, in the enlarged example illustrated in FIG. 2, an edge 200 of the solar panel 110 is to be secured with the frame 115 for a rooftop installation. The edge 200 extends longitudinally along a side of the solar panel 110. The edge 200 is positioned perpendicular to a longitudinal axis 205 of the frame 115 and is aligned proximal to an end of the frame 115 on the longitudinal axis 205. As a result, only a small portion of the edge 200 is in contact with the frame 115. As should be appreciated, traditional fastening method such as welding would not provide sufficient bonding strength between the edge 200 and the frame 115 because the contacting area is too small. Moreover, after welding, the connection between the edge 200 and the frame 115 is permanent and cutting and/or drilling will be required to undo the welded connection. Furthermore, operating welding processes on rooftops would be laborious and prone to a variety of accidents, such as fire and/or falls.

The clamp assembly 105 is configured to fastens and secures two or more perpendicular braces, such as the edge 200 and frame 115 in FIG. 2, in a low-cost and easy manner. As shown, the clamp assembly 105 is a U-shaped clamp having a clamp body 210 and a fastening set 215. In one version, the clamp body 210 is made of a metal and/or an alloy, so that the clamp assembly 105 is configured to provide an electrical path for the solar panel 110. In another version, the clamp body 210 is made of a non-conductive material. In the illustrated example, the fastening set 215 are at least two metal bolts configured to facilitate the connection and securement of the edge 200 and the frame 115. As should be appreciated, the fastening set 215 may be any fasteners made of other electrical conductive and/or non-conductive materials. As shown, one of the bolts is placed on the contacting area of the edge 200 and the frame 115, and the other bolt is placed on another section of the frame 115 without contacting the edge 200 of the solar panel 110. Once the bolts are tightened, the clamp assembly 105 locks the edge 200 and frame 115 in place in a secured manner.

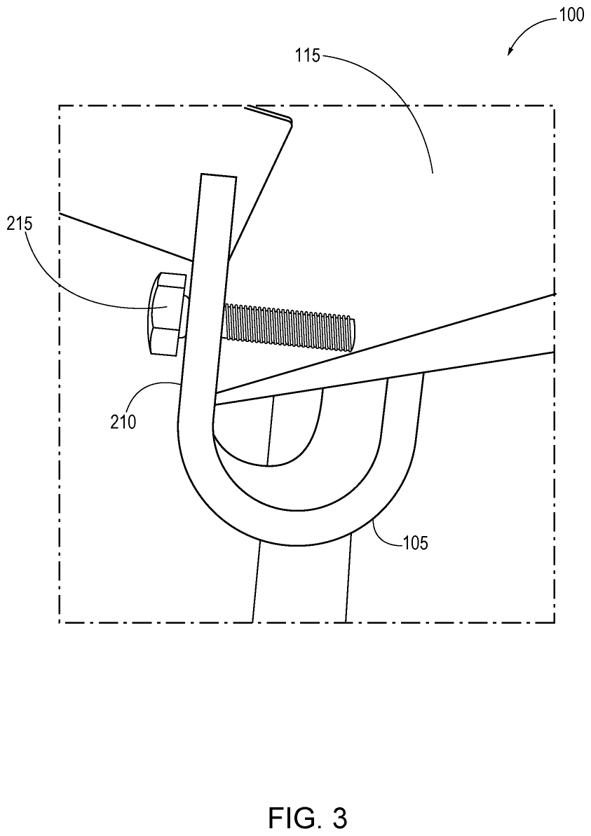

FIG. 3 illustrates an enlarged end view of the system 100 according to the example shown in FIG. 2. As illustrated, one of the two bolts of the fastening set 215 is only in contact with the frame 115. In this way, the clamp assembly 105 is fixed in place against the frame 115 while the clamp assembly 105 secures the edge 200 against the frame 115. The clamp assembly 105 thus provides sufficient bonding strength to connect the edge 200 and the frame 115 together. Moreover, the connection may be easily undone by untightening the fastening set 215 of the clamp assembly 105 without any cutting or drilling involved.

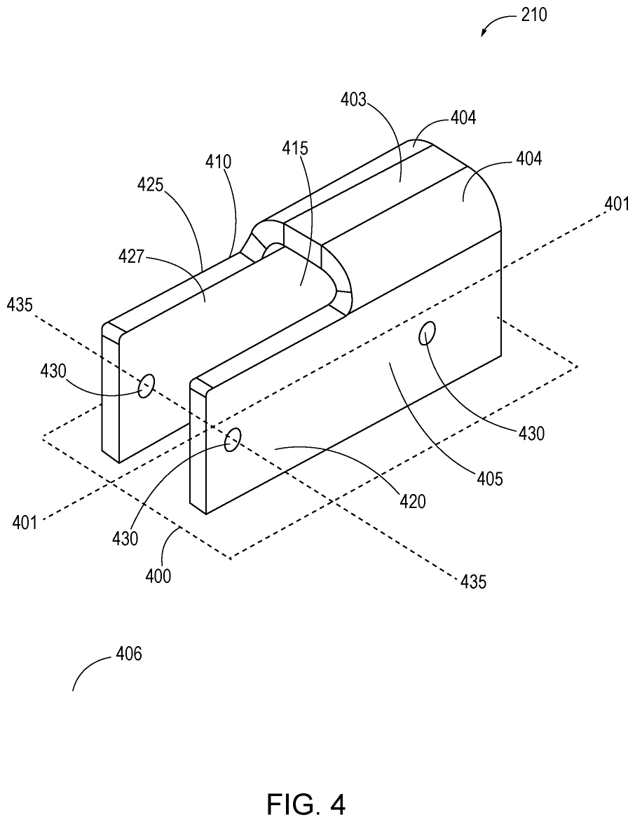

FIG. 4 illustrates a perspective view of the clamp body 210 according to one embodiment. As shown, the clamp body 210 forms a flipped U-shaped profile on a first plane 400, where the clamp body 210 extends longitudinally along a first axis 401 to form a length. The clamp body 210 is curved at a center portion 403 and extends to two opposite sides perpendicular to the first axis 401 to form two transitional portions 404. The clamp body 210 extends from the transitional portions 404 in a flat manner to a pair of ends located on the first plane 400 forming a first face 405 and a second face 410, where each face corresponds to a substantially flat side of the clamp body 210. The first face 405 and the second face 410 defines a opening 415. The opening 415 is configured to hold the solar panel 110 and/or the frame 115 to be connected against the clamp body 210. In the illustrated example, the first face 405 is parallel to the second face 410, such that both the first face 405 and the second face 410 are oriented in a substantially vertical direction with respect to the first plane 400. In another example, the first face 405 is inclined at an angle more than 90 degrees with respect to the first plane 400. As should be appreciated, other inclinations are possible for the first face 405 and/or the second face 410 with respect to the first plane 400.

In the example shown in FIG. 4, the first face 405 extends longitudinally along the length of the clamp body 210 to form a first tab 420. The second face 410 extends longitudinally along the length of the clamp body 210 to form a second tab 425, where the first tab 420 is parallel to the second tab 425. As shown, the first tab 420 and the second tab 425 are equal in length. According to other examples, the first tab 420 and the second tab 425 may have different lengths such that the first tab 420 may be longer and/or shorter than the second tab 425. The first tab 420 and the second tab 425 define a cutout 427 in communication with the opening 415. The cutout 427 is located proximal to the transitional portion 404 and is configured to facilitate a user to place the first tab 420 and/or the second tab 425 at a space and/or an angle that is difficult to be reached by other portion of the clamp assembly 105. For example, the user may place a connecting part, such as the contacting area of the solar panel 110 and the frame 115, inside the opening 415 through the cutout 427 to ensure a flush contact between the connecting part and the clamp body 210.

The first face 405 and the second face 410 each defines one or more apertures 430. In one particular version, only the first face 405 defines one or more apertures 430. As shown in FIG. 4, the first face 405 and the second face 410 each defines two apertures 430. The apertures 430 on the first face 405 are aligned with a third axis that is parallel to the first axis 401. Each of the apertures 430 on the first face 405 corresponds to each of the aperture 430 on the second face 410 along axes transverse the first axis 401, such as a second axis 435. As should be appreciated, other arrangements of the apertures are available in other embodiments.

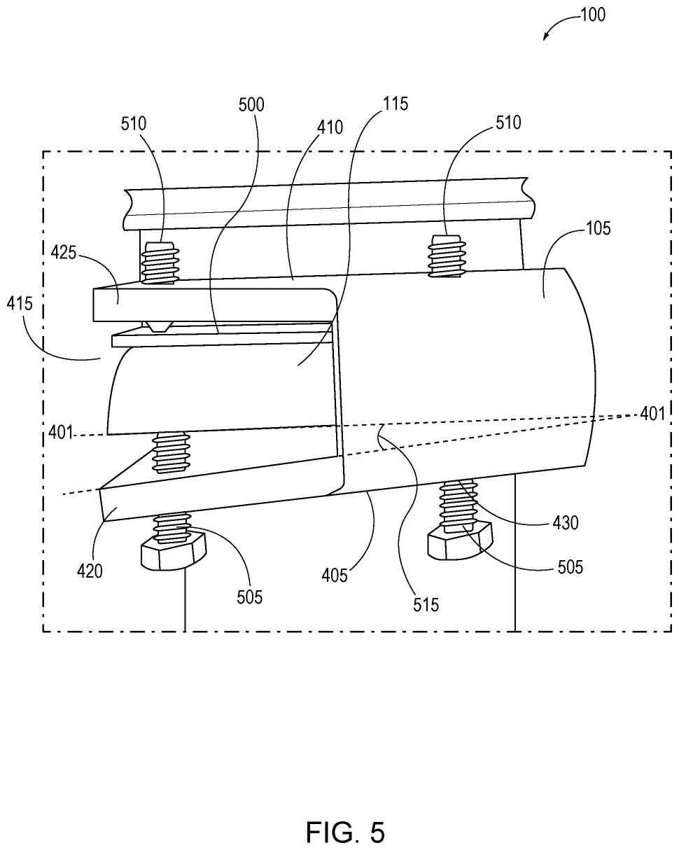

An enlarged top view of the system 100 according to one example is illustrated in FIG. 5. As shown, the system 100 includes a bracket 500, the frame 115, and the clamp assembly 105. Both the bracket 500 and the frame 115 are positioned longitudinally along the first axis 401. In other words, the bracket 500 is parallel to the frame 115. The clamp assembly 105 fastens the frame 115 and the bracket 500 together within the opening 415.

The fastening set 215 of the clamp assembly 105 includes two first bolts 505 and two second bolts 510. The first bolts 505 and the second bolts 510 are configured to be threaded into the apertures 430 to facilitate the clamp assembly 105 to generate a clamping force against the bracket 500 and the frame 115. In the illustrated example, the first bolts 505 are hex head bolts configured to be threaded into the apertures 430 on the first face 405 to adjust the amount of the clamping force the user desires. Specifically, when one of the first bolts 505 located on the first tab 420 is tightened, the first tab 420 is configured to deviate from the first axis 401 at a bending angle 515. As should be appreciated, the bigger the bending angle 515, the larger amount of the clamping force the clamp assembly 105 generates. The second bolts 510 in this example are cone point screws configured to be threaded into the apertures 430 on the second face 410 to adjust the distance between the bracket 500 and the cone point screws. As should be appreciated, the shorter the distance between the bracket 500 and the cone point screws, the lesser the bending angle 515 is required to generate a certain amount of the clamping force. As shown, the length of the second bolts 510 is configured to be shorter than the length of the first bolts 505. The shorter length of the second bolts 510 facilitates the clamp assembly 105 to fit into a smaller operational space. According to other embodiments, the fastening set 215 may include other quantities and/or styles of fasteners. Alternatively or additionally, the first bolts 505 may be threaded into the apertures 430 on the second face 410 and the second bolts 510 may be threaded into the apertures 430 on the first face 405. In other words, the user may reverse the positions of the first bolts 505 and/or the second bolts 510 to satisfy special fastening requirements.

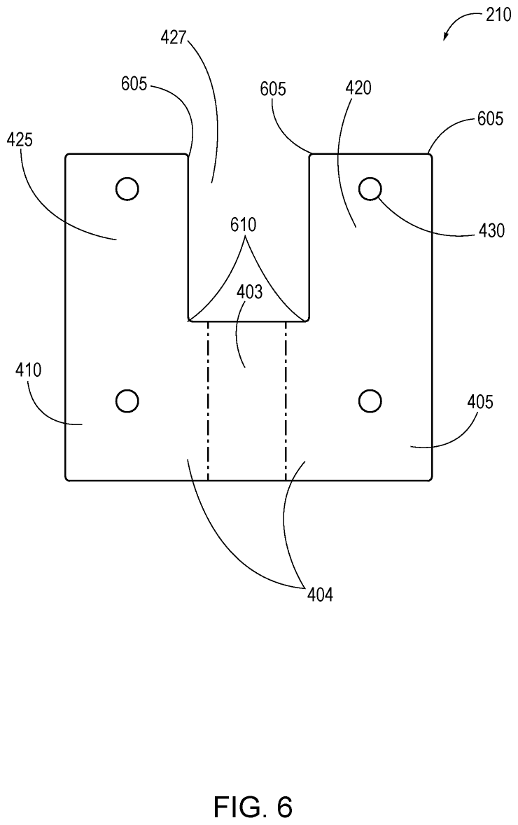

FIG. 6 illustrates a top view of the clamp body 210 in a flat state according to one example. As shown. the clamp body 210 of the clamp assembly 105 is made of a rectangular metal plate having a thickness. According to one version, the thickness is 0.25 inches (6.35 millimeters). In other versions, the thickness may be larger and/or smaller than 0.25 inches (6.35 millimeters). In a preferred embodiment, the metal plate is made of steel. As should be appreciated, other metals having similar strength, elasticity, and/or other characteristics may be used. The metal plate may be coated and/or surface processed to obtain desirable aesthetics and protection against corrosion. According to some examples, the clamp body 210 is manufactured by stamping, puncturing, bending, cutting, and/or other machining processes. In one particular example, the clamp body 210 is made of a composite material manufactured by processes including, but not limited to, heat injection molding.

In the illustrated example, the metal plate of the clamp body 210 includes six 605˜2 and two 610˜2. The 605˜2 are configured to provide a smooth handling for users to reduce risks of injuries in use. The 610˜2 are configured to facilitate the manufacturing process of the clamp assembly 105 such as providing a wide angle for easy bending of the sheet metal. According to one embodiment, the cutout 427 is die-cut with a 1.5 inches (38.1 millimeters) width and 2 inches (50.8 millimeters) length positioned in the center of one of the 4 inches (101.6 millimeters) long sides of a square metal plate. In other examples, the rectangular metal plate may have two 4.5 inches (114.3 millimeters) sides and two 4 inches (101.6 millimeters) sides. As should be appreciated, the rectangular metal plate may be in other desirable dimensions to accommodate specific applications.

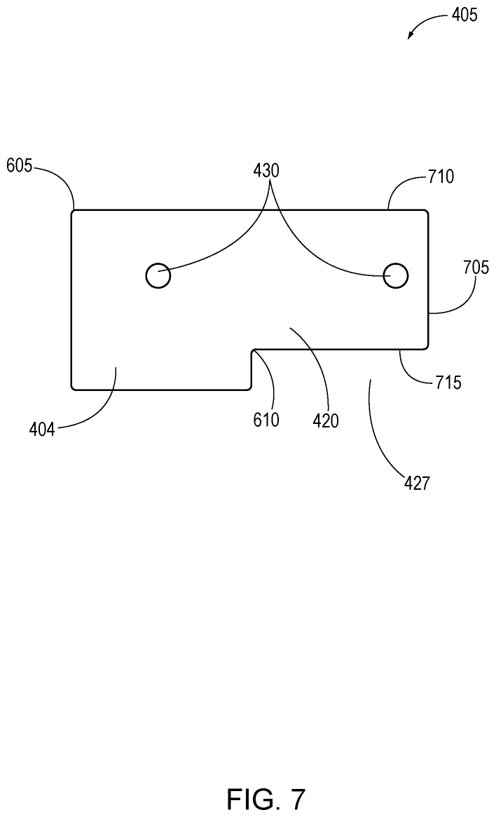

FIG. 7 illustrates a side view of the first face 405 according to one example. As should be appreciated, the same side view illustration may represent the second face 410 when both the first face 405 and the second face 410 are in the same dimensions. As shown, the first face 405 includes a first end 705, a second end 710, and a cut end 715. The second end 710 is positioned parallel and opposite to the 720. The first end 705 is in communication with both the second end 710 and the 720.

In one use example, the edge 200 of the solar panel 110 is placed perpendicular to a frame 115 forming a connection area. The clamp assembly 105 having two second bolts 510 on the second face 410 and two first bolts 505 on the first face 405 is advanced towards the frame 115 near the connection area so that the frame 115 is set into the opening 415 and touches against the center portion 403 of the clamp body 210 of the clamp assembly 105. The connection area is positioned in the cutout 427 of the clamp assembly 105, with the second tab 425 placed outside the edge 200 of the solar panel 110 and the first tab 420 placed outside the frame 115. Put differently, the second tab 425 and the first tab 420 form a sandwich arrangement with respect to the connection area. Once the clamp assembly 105 is at a desired position, the first bolts 505 are tightened to cause the second bolts 510 to bite down into the edge 200 of the solar panel 110 and/or the frame 115 without tighten the second bolts 510. As should be appreciated, the first bolts 505 are also secured against the edge 200 of the solar panel 110 and/or the frame 115 as a result of the tightening.

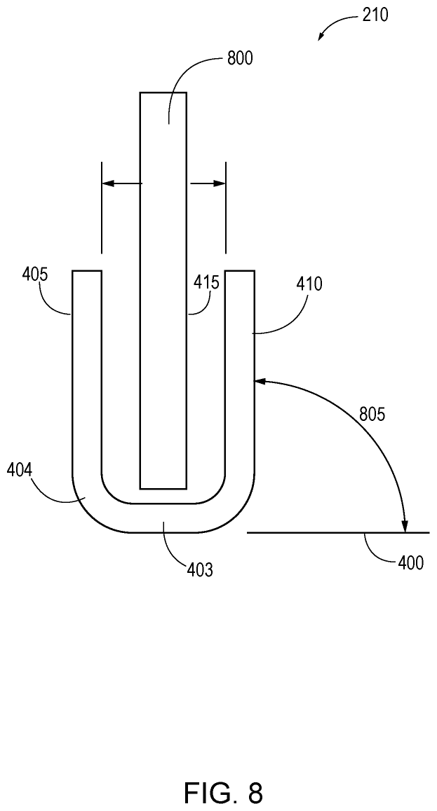

FIG. 8 illustrates a cross-sectional view of the clamp body 210 and a method of manufacturing according to one embodiment. As shown, the clamp body 210 is manufactured by using a press break machine 800. The press break machine 800 is configured to bend the rectangular sheet metal at positions proximal to the transitional portions 404, so that the second face 410 is positioned at a side angle 805 with respect to the first plane 400. In one example, the side angle 805 is set at 91 degrees. In other embodiments, the side angle 805 is set at other angles. As should be appreciated, the larger the side angle 805, the stronger the spring bias the clamp body 210 has and thus is able to create a stronger clamping force against the connecting point of the edge 200 and the frame 115.

In one version, the aperture 430 is manufactured by drilling and/or tapping to form a 5/16 inches thread. In one embodiment, the apertures 430 are positioned proximal to the center of the first tab 420 and/or the second tab 425 along the length of the clamp body 210.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Aperture” generally refers to a hollow portion through a solid body, wall or a surface. An aperture may be any shape. For example, an aperture may be, but is not limited to, circular, triangular, or rectangular. An aperture may also have varying depths and may extend entirely through the solid body or surface or may extend through only one side of the solid body.

“Bracket” generally refers to a flat or curved component that forms part of another object. Typically, but not always, the bracket has a generally flat shape.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Edge” generally refers to a border where an object or area begins or ends, such as the outer perimeter of a solar panel. The edge is typically in the form of a line or line segment that is at the intersection of two plane faces or of two planes of an object or space. The edge of a solar panel is typically where the frame or support structure is attached, and the edge plays a crucial role in the structural integrity and mounting of the solar panels.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Frame” generally refers to a structure that forms part of an object and gives strength and/or shape to the object. In the solar panel industry, the frame typically provides an electrical path for grounding the electricity generated by the solar panels.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Longitudinal” generally refers to the length or lengthwise dimension of an object, rather than across.

“Opening” generally refers to a space or slot that something can pass through and/or be placed into.

“Press brake machine” generally refers to an equipment used to bend and form sheet metal. Press brake machines are tools in the metal fabrication industry that facilitate the bending and shaping of metal sheets to create various structures and products. Press brake machines may be operated by mechanical, hydraulic, and/or electric power.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 clamp assembly
110 solar panel
115 frame
200 edge
205 longitudinal axis
210 clamp body
215 fastening set
400 first plane
401 first axis
403 center portion
404 transitional portion
405 first face
410 second face
415 opening
420 first tab
425 second tab
427 cutout
430 aperture
435 second axis
500 bracket
505 first bolt
510 second bolt
515 bending angle
605 first angle
610 second angle
705 first end
710 second end
715 cut end
800 press break machine
805 side angle

What is claimed is:

1. A system, comprising:
a first frame,
a second frame,
a clamp connecting the first frame to the second frame,
wherein the clamp has a body, and
wherein the body has a U-shaped profile.

2. The system of claim 1, further comprising:
one or more fasteners; and
wherein the fasteners are coupled to the body.

3. The system of claim 2, further comprising:
a solar panel being supported by the first frame.

4. The system of claim 2, wherein the body is curved at a center portion and extends on each side in a flat manner to a pair of ends located on a first plane.

5. The system of claim 4, wherein the body includes a first face and a second face.

6. The system of claim 5, further comprising
an opening defined by the first face and the second face; and
wherein the opening is configured to hold the frames to be connected.

7. The system of claim 5, wherein a plurality of apertures are defined by the body.

8. The system of claim 2, wherein the fasteners include two hex head bolts and two cone point screws.

9. The system of claim 8, wherein the fastener is configured to be threaded into the apertures and to facilitate the clamp to provide a pressured connection.

10. The system of claim 2, wherein the body is made of a metal plate having a thickness.

11. The system of claim 2, wherein the body is surface-processed to obtain desirable aesthetics and protection against corrosion.

12. The system of claim 2, wherein the body is made of a composite non-metal material.

13. The system of claim 1, wherein the frame is configured to provide an electrical path.

14. The system of claim 1, wherein the clamp is configured to create an electrical bond between the frames.

15. The system of claim 14, wherein the clamp is configured to provide a maximum current protection level of 25 amps.

16. A method,
forming a connection area by placing a first frame proximal to a second frame;
advancing a U-shaped clamp having two cone point screws and two hex head bolts towards the connection area; and
tightening the two hex head bolts against one of the frames to cause the cone point screws bite down into the other frame without tighten the cone point screws.
